(19) United States
(12) Patent Application Publication
(10) Pub. No.: US 2026/0345300 A1
(43) Pub. Date: Nov. 5, 2026

(54) SPRUELESS MILLING PROCESS FOR MULTIPLE DENTAL COMPONENTS MILLED AT THE SAME TIME WITH STANDARD EQUIPMENT AND FIXTURES

(71) Applicant: Jordan Greenberg, Milford, NH (US)

(72) Inventor: Jordan Greenberg, Milford, NH (US)

(21) Appl. No.: 19/461,714

(22) Filed: Jan. 27, 2026

Related U.S. Application Data
(60) Provisional application No. 63/750,218, filed on Jan. 27, 2025.

(51) Int. Cl. A61C 13/00

(52) U.S. Cl. CPC A61C 13/0006; A61C 13/0004; A61C 13/0028

(57) ABSTRACT

A sprueless milling process produces multiple dental components from a single puck without requiring sprues or connecting bridges using standard, off-the-shelf milling equipment. The process includes milling a first side of the puck to partially form dental components, wherein interior cavities are milled to finished form and exterior sides are milled to an equator line, leaving a continuous skirt preventing through-holes. Wax is added to fill cavities, voids, and headspace, forming a wax matrix supporting the components. A second side is milled to complete the components, fully separating each component from remaining puck material while supported by the wax matrix. The process eliminates manual sprue removal and associated grinding, producing smooth, unblemished surfaces. The same puck can be reused across multiple milling events in unused zones.

### RELATED APPLICATIONS

This application claims the benefit of U.S. Provisional Application Ser. No. 63/750,218, filed Jan. 27, 2025 entitled SPRUELESS MILLING PROCESS FOR MULTIPLE DENTAL COMPONENTS MILLED AT THE SAME TIME, the entire disclosure of which is herein incorporated by reference.

### FIELD OF THE INVENTION

This application relates to the milling of dental components, and more particularly, to sprueless milling of multiple dental components at the same time with equipment and fixtures.

### BACKGROUND OF THE INVENTION

Computer-aided design and computer-aided manufacturing (CAD/CAM) technology has been widely adopted in the dental field for producing dental restorations and components. Traditional CAD/CAM milling processes for dental components typically require the use of sprues or connecting bars to prevent milled components from separating prematurely from the material block during the milling process. A sprue can be defined as a small bridge of material that remains after milling and connects the milled component or components together with the remainder of the starting block of material.

In conventional milling processes, after the dental components are milled, technicians must manually cut off the sprues to separate the dental components from the remnant material block. The residual portions of the sprues remaining on the outer surfaces of the dental components must then be manually ground away using dental low-speed handpieces or other hand tools. This manual grinding and polishing process is not only time-consuming and labor-intensive, but also introduces several disadvantages. Manual processing can produce inaccuracies between the designed and actual dental components, with surface losses and irregularities that affect aesthetics and function. The rough surfaces left after manual grinding can accelerate pigmentation and discoloration, and can cause excessive abrasion of adjacent or opposing teeth. Furthermore, vibration during manual grinding may cause chipping on thin parts of the dental components, especially at edges, and can introduce local stress and micro-defects to the surface that reduce long-term stability and reliability, potentially leading to premature fracture and restorative failure.

Accordingly, there exists a need for an improved milling process that can produce multiple dental components from a single starting block of material without requiring sprues or other connecting bridges, thereby eliminating the need for manual sprue removal and the associated grinding and polishing steps that compromise the accuracy, surface quality, and structural integrity of the final dental components.

### SUMMARY OF THE INVENTION

This invention overcomes disadvantages of the prior art by providing a system and method for sprueless milling of multiple dental components from a single puck without requiring sprues or connecting bridges between the dental components and the starting block of material. The invention eliminates the need for manually cutting off sprues to separate the dental components from the remnant material block, and further eliminates the need for manually grinding and polishing the residual portions of sprues that remain on the outer surfaces of the dental components after sprue removal.

The sprueless milling process described herein produces dental components with smooth, unblemished exterior surfaces that are free from visible marks, local grinding traces, and chipping that result from manual sprue removal in conventional processes. By eliminating manual grinding and polishing steps, the invention avoids introducing inaccuracies between the designed and actual dental components, prevents surface losses and irregularities that affect aesthetics and function, and eliminates the accelerated pigmentation and discoloration that occurs on rough surfaces left after manual grinding. The invention further avoids excessive abrasion of adjacent or opposing teeth that results from rough surfaces on conventionally processed dental components. The sprueless process eliminates vibration-induced chipping on thin parts of dental components, especially at edges, and avoids introducing local stress and micro-defects to the surface that reduce long-term stability and reliability and can lead to premature fracture and restorative failure in conventional processes.

The sprueless milling process can be performed using standard, commercially available milling equipment and standard milling tools, without requiring specialized machinery or custom tooling. The process can use standard, off-the-shelf pucks that are commercially available in sizes ranging between 98 and 110 mm in diameter and thicknesses ranging between 10 mm and 35 mm. This compatibility with standard equipment and materials makes the sprueless milling process accessible to dental laboratories and manufacturing facilities that already possess standard CNC milling equipment, without requiring substantial capital investment in specialized machinery.

In an embodiment, a method for sprueless milling of multiple dental components from a single puck includes milling a first side of the puck to partially form a plurality of dental components, wherein milling the first side includes milling interior cavities of the dental components to a finished form and milling exterior sides of the dental components up to an equator line of each dental component, wherein a continuous skirt of material remains around each dental component preventing formation of through-holes in the puck. The method further includes adding wax to the puck, wherein the wax fills cavities within the dental components, voids between the dental components, and headspace above the dental components to form a wax matrix that supports the partially milled dental components. The method further includes milling a second side of the puck to complete the dental components, wherein milling the second side completely separates each dental component from remaining puck material such that each dental component is surrounded by an air gap and is connected only to the wax matrix.

In various embodiments, milling the first side can further include milling retention features into boundary walls of remaining puck material, wherein the retention features provide mechanical interlocking with the wax matrix. The retention features can include horizontal grooves milled into the boundary walls using lateral tool movements. The retention features can alternatively or additionally include at least one of islands, dimples, extensions, or undercuts formed in the boundary walls.

In various embodiments, milling the first side and milling the second side can optionally utilize predominantly lateral tool movements that apply force laterally against solid sections of the puck. The puck can be circular and held by a surrounding fixture, and the tool movements can start at a center of the puck and work progressively outward toward a perimeter.

In various embodiments, milling the first side can include milling the first side at a greater depth at a center of the puck and at a gradually reduced depth moving toward edges of the puck, resulting in a thicker wax matrix at the center that provides enhanced structural support during the second milling step.

The method can further include extracting the dental components from the wax matrix by melting the wax, and removing residual wax from surfaces of the dental components by heating the dental components in an oven to burn away the residual wax.

In various embodiments, the puck can remain mounted in a milling machine throughout milling the first side, adding wax, and milling the second side. The method can include pausing the milling machine after milling the first side, cleaning the puck while the puck remains mounted in the milling machine, and resuming the milling machine to mill the second side after the wax has cured.

In various embodiments, the method can include removing the puck from a milling machine after milling the first side, heating and cleaning the puck externally to the milling machine, adding the wax while the puck is external to the milling machine, and remounting the puck in the milling machine for milling the second side.

The method can further include milling a second set of dental components from the same puck after the first set of dental components are complete, wherein a first milling event produces a first group of finished dental components, leaving a first cutout in the puck defined by a first boundary wall, and performing a second milling event on the puck, wherein the second milling event produces a second group of dental components in an unused zone according to the same process, leaving a second cutout in the puck defined by a second boundary wall that does not overlap with the first boundary wall.

The method can further include identifying an unused zone in the puck, wherein identifying the unused zone includes maintaining digital records of three-dimensional coordinates of all previously milled areas of the puck, calculating available unused zones based on the digital records, and evaluating multiple potential layouts for the second group of dental components within the unused zones. The method can further include determining that the puck has reached end of useful life when a largest remaining unused zone is insufficient to accommodate a smallest dental component with an adequate boundary wall.

In an embodiment, a system for sprueless milling of multiple dental components includes a milling machine having a fixture adapted to hold a puck, and a controller programmed to execute milling instructions for milling a first side of the puck to partially form a plurality of dental components, wherein milling the first side includes milling interior cavities of the dental components and milling exterior sides of the dental components up to an equator line, leaving a continuous skirt of material around each dental component. The controller is further programmed to execute milling instructions for milling a second side of the puck to complete the dental components, completely separating each dental component from remaining puck material while the dental components remain supported by a wax matrix.

The controller can be programmed to execute tool paths comprising predominantly lateral movements that apply force laterally against solid sections of the puck. The controller can be programmed to mill retention features into boundary walls during milling of the first side.

The system can further include a tracking module programmed to maintain digital records of three-dimensional geometry of the puck including locations of previously milled areas, identify unused zones of the puck, and generate milling instructions for subsequent milling events in the unused zones with boundary walls that do not overlap with previously milled areas.

### BRIEF DESCRIPTION OF THE DRAWINGS

The invention description below refers to the accompanying drawings, of which:

FIG. 1 is a perspective view of a puck with partially milled dental components, according to an exemplary embodiment.

FIG. 2 is a top view of the puck with partially milled dental components, according to an illustrative embodiment.

FIG. 3 is a close-up perspective view of the puck with partially milled dental components showing retention features, according to an illustrative embodiment.

FIG. 4 is a perspective view of a puck partially filled with wax, according to an exemplary embodiment.

FIG. 5 is a perspective view of the second side of the puck with the exterior sides of the dental components fully milled, according to an illustrative embodiment.

FIG. 6 is a perspective view of a milling process that has been paused for cleaning, according to an illustrative embodiment.

FIG. 7 is a perspective view of a user spraying distilled water to clean away milling dust, according to an illustrative embodiment.

FIG. 8 is a perspective view of a user using compressed air to clean away milling dust and dry the puck, according to an illustrative embodiment.

FIG. 9 is a perspective view of the clean and dry puck returned to the flat orientation with molten wax poured into the well, according to an illustrative embodiment.

FIG. 10 is a perspective view of dental components that have been separated from the wax base, according to an illustrative embodiment.

FIG. 11 is a perspective view of the wax-covered dental components in an oven, according to an illustrative embodiment.

FIG. 12 is a perspective view of finished dental components after the wax has been burned away, according to an illustrative embodiment.

FIG. 13 is a perspective view of a puck that has already had several dental components milled, completed, and removed, and is now ready to have new dental components milled out, according to an illustrative embodiment.

FIG. 14 is a perspective view of a subsequent milling showing the well filled with wax, according to an illustrative embodiment.

FIG. 15 is a perspective view of the subsequent milling after the second side has been completed, showing the subsequent dental components held in place by the wax block, according to an illustrative embodiment.

FIG. 16 is a perspective view showing the tool path for milling the inside of the cavity after roughing has been completed, according to an illustrative embodiment.

FIG. 17 is a perspective view showing the tool path for the bottom surfaces of the dental components, also called the margins, according to an illustrative embodiment.

FIG. 18 is a perspective view showing the tool path for finishing the exterior sides of the dental components, according to an illustrative embodiment.

FIG. 19 is a perspective view showing the tool path for roughing the outer surfaces of the second side, according to an illustrative embodiment.

### DETAILED DESCRIPTION

The description herein includes a sprueless milling process for dental components and system of use. There are a great many possible implementations of the invention, too many to describe herein. Some possible implementations that are presently preferred are described below. It cannot be emphasized too strongly, however, that these are descriptions of implementations of the invention, and not descriptions of the invention, which is not limited to the detailed implementations described in this section but is described in broader terms in the claims. Although this invention is disclosed in the context of certain preferred embodiments and examples, it should be understood by those skilled in the art that the present invention extends beyond the specifically disclosed embodiments and/or uses of the invention and obvious modifications and equivalents thereof. Further, the terms and phrases used herein are not intended to be limiting but rather to provide an understandable description of the invention.

Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined.

References to “one embodiment”, “an embodiment”, “another embodiment”, “one example”, “a further embodiment”, “some embodiments”, “various embodiments”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. The appearance of the phrase “in one embodiment” in various places in the specification are not necessarily all referring to the same embodiment, nor are separate or alternative embodiments mutually exclusive of other embodiments. Some embodiments, illustrating its features, will now be discussed in detail. The words “having,” “containing,” and “including,” and other forms thereof, are intended to be equivalent in meaning and be open ended in that an item or items following any one of these words is not meant to be an exhaustive listing of such item or items, or meant to be limited to only the listed item or items. Further, the terms “a” and “an” herein do not denote a limitation of quantity, but rather denote the presence of at least one of the referenced items. Moreover, various features are described which may be exhibited by some embodiments and not by others. Similarly, various features are described which may be included in some embodiments but not in other embodiments. All illustrations of the drawings are for the purpose of describing selected versions of the present invention and are not intended to limit the scope of the present invention.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

This invention overcomes disadvantages of the prior art by providing a system and method for sprueless milling of multiple dental components from a single starting block of material at the same time. The invention can also overcome disadvantages of the prior art by eliminating the need for sprues or other bridges connecting dental components to the starting block, thereby avoiding manual removal of sprues and subsequent grinding and polishing that can introduce surface irregularities and reduce the accuracy of the final dental components.

In various embodiments, a sprueless milling process can include milling a first side of a puck to form cavities within hollow dental components and exterior sides of the dental components up to or close to an equator line, wherein the equator line represents the widest area around each dental component from a top-down view. The first milling step can mill the sides of the dental components up to or close to the equator line without extending more than slightly beyond the equator line, ensuring no holes or openings are created through the puck that would allow wax to leak out when wax is added. This creates a continuous skirt of connected material around the equator of each dental component that prevents wax from pouring through the puck when liquid wax is poured into the first side of the puck. After the first milling step, wax is poured into the pockets formed by the first milling step to fill cavities within the dental components, voids between the dental components, and headspace above the dental components, thereby creating a wax matrix with a wax base that securely holds the partially milled dental components in place. Retention features can be purposefully created during the first milling step, such as horizontal grooves, dimples, extensions, islands, or knobs milled into sidewalls of the remaining puck to provide additional grip to hold the wax matrix securely in place. Variable depth milling can be used wherein dental components farthest from the support are cut on the first side at a deeper depth, resulting in a thicker wax base that provides maximum wax strength at weaker areas such as the middle of the puck during the second milling step, while allowing the puck thickness to be thicker closer to the edges to help support the wax matrix.

In a second milling step, a second side of the puck is milled to complete the exterior sides of the dental components, fully separating each dental component from the puck while the wax matrix continues to support the dental components.

A reusable puck system can allow the same standard puck to be reused in multiple milling events by milling different groups of dental components in unused zones of the puck. Each milling event can mill one or more dental components at a time, with those dental components surrounded by a boundary wall that creates a well for wax containment. Future milling events can reuse the same puck by milling in different areas of the puck while leaving a complete boundary wall around all dental components milled in a single milling event. The system can track which areas of the puck have already been milled and lay out new dental components in unused zones of the puck, ensuring that the boundaries of different groups do not overlap so that wax can be held by the boundary wall of each group.

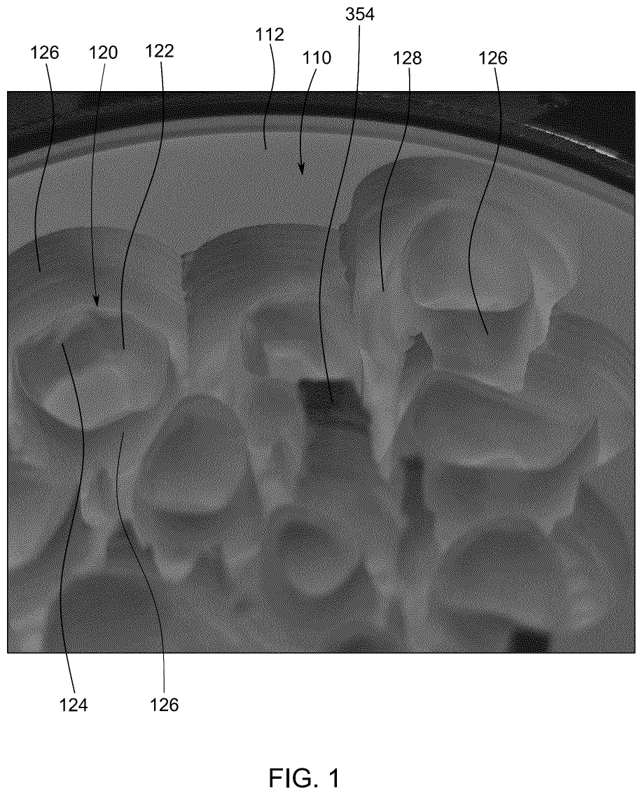

FIG. 1 is a perspective view of a puck 110 with partially milled dental components 120, according to an exemplary embodiment. The puck 110, also referred to as a starting block of material, is a standard, commercially available disk of material from which the dental components are milled. The puck can be made of various materials suitable for dental applications, including ceramic materials such as zirconia ceramic material, resin material, or others. In various embodiments, the puck can include a zirconia-based ceramic material. Standard, off-the-shelf pucks can include commercially available pucks that can be in a range between 98 and 110 mm in diameter. The commercially available standard pucks can have varying thicknesses that can be in a range between 10 mm and 35 mm. The commercially available standard pucks can have a 10 mm step around the perimeter for fixturing in the machine. The puck can be held by a fixture along one side of the puck, fixtures along multiple sides of a puck, and/or fixtures that completely or partially encircle a puck.

The milling process can start with milling the first side 112 of the puck 110. The first side 112 can start with milling the interior surfaces of the dental components 120, which can also be referred to as the cavity side of the dental components. This first step can include milling the cavity 122 of each of the hollow dental components 120 to its final finished form. This first milling step can also include milling at least a portion of the exterior sides 126 of each dental component. In various embodiments, the area of the exterior side 126 of the dental component where the dental component is the widest can be referred to as the equator 128. In the first milling step, the exterior sides 126 of the dental components can be milled up to or close to the equator line 128, but preferably not beyond the equator line. Milling up to the equator line 128 around the outside of the dental component, and not milling more than slightly beyond the equator line, can help to ensure that no holes or openings are created through the puck 110 that would allow wax to leak out when wax is added in a subsequent step. Put another way, when the milling process does not extend beyond the equator 128 of the dental component, the equator line of the dental component can remain entirely connected to the original puck of material. This skirt of connected material around the equator 128 of the dental component can prevent wax from pouring through the puck when the liquid wax is poured into the first side 112 of the puck.

After this first milling step, the hollow interior of each dental component has been completely milled to form the finished cavity 122, and the exterior side 126 of the dental component has been milled down partway along the sidewall, up to or close to, but not significantly beyond the equator 128 of the emerging dental component. At this point, the dental components can be referred to as half-milled or partially milled.

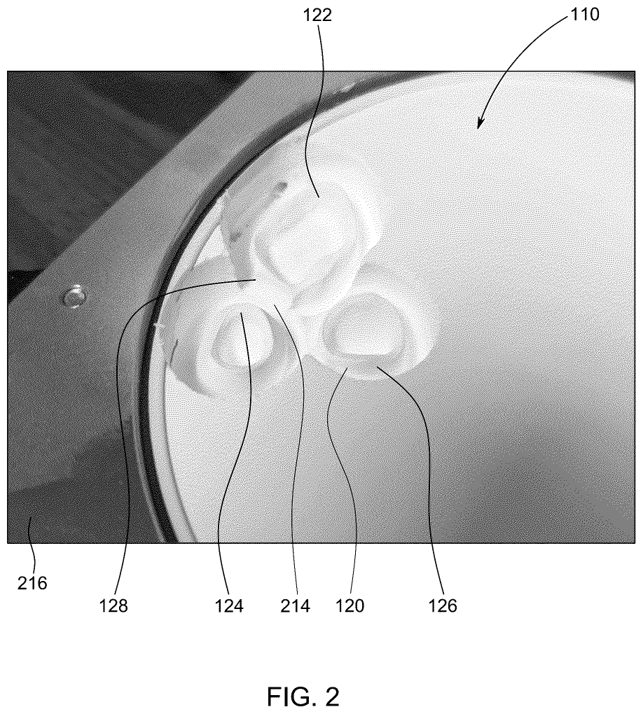

FIG. 2 is a top view of the puck 110 with partially milled dental components 120 of FIG. 1, according to an illustrative embodiment. The top view shows the first side 112 of the puck after the first milling step has been completed. The cavities 122 within the hollow dental components 120 are visible, as are the interior sides 124 of the dental components that define the cavities. The exterior sides 126 of the dental components have been milled down to the equator 128, leaving a continuous skirt 214 of material around each dental component that remains connected to the puck 110. This continuous skirt ensures that the puck remains intact without through-holes that would allow wax leakage.

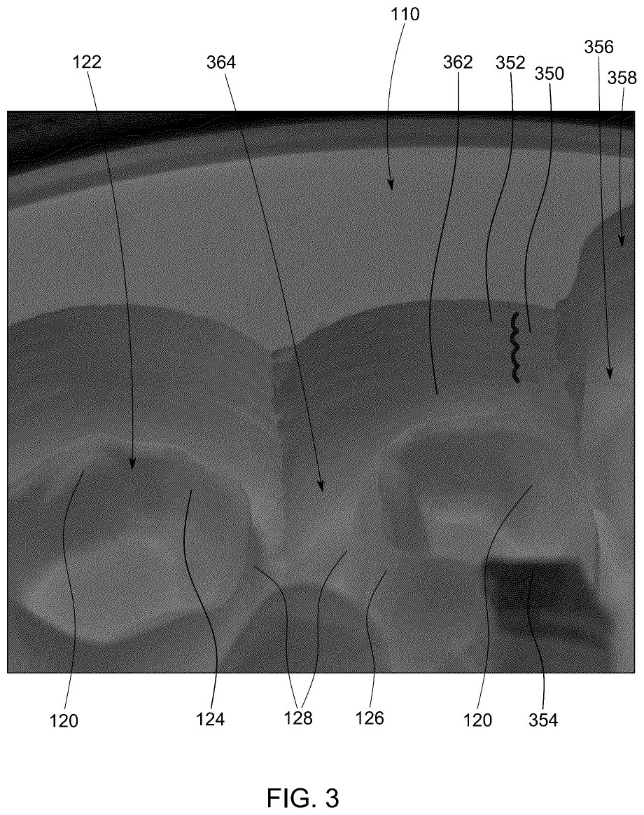

FIG. 3 is a close-up perspective view of the puck 110 with partially milled dental components 120 and showing retention features 350, according to an illustrative embodiment. The milling process can mill out a well in the first surface of the puck. The milled well 356 can include cavities 122 within the dental components and voids 364 between the dental components. The cavities 122 can be defined by the interior sides 124 of the dental components, and the voids 364 can be defined by the external sides 126 of the dental components and the sidewalls or boundaries 362 of the remaining puck material. Together, the voids 364 and the cavities 122 form a part of the well. The well can further include additional headspace 358 above the dental components and below the plane of the first side 112 of the puck. In a later step the well can be filled with wax, including filling the cavities 122, the voids 364, and the headspace 358. The headspace 358 allows the wax to form with a solid wax base that can be connected to all of the cavities and the voids, thereby fully encircling the dental components and connecting them to the wax base in a unitary wax matrix. As the wax is poured to fill the cavities and the headspace, the dental components are encircled in the bracing wax. As the wax is further poured to fill the headspace, a wax base is formed and the dental components are braced to the wax matrix. By fully encircling and bracing the milled and exposed portions of the dental components, the wax is able to lock the partially milled dental components in place.

The wax matrix supports the individual dental components as they are being cut completely and without sprues during the second milling step. The remaining portions of the puck also support the wax matrix. In order for the puck to provide optimal support for the wax matrix, the portions of the puck that remain after the first milling step can be cut in ways that enhance support for the wax and secure it in place. The first milling step can purposefully create retention features in the sidewalls and remaining portions of the puck to support the wax and secure it in place. These retention features 350 can include extensions, indentions, grooves, islands 354, dimples, knobs, or other geometric features. For example, the sidewalls of the remaining portion of the puck can have a plurality of horizontal grooves 352 cut into those sidewalls. These retention features 350 can provide additional grip or mechanical interlock to hold the wax matrix securely in place within the puck. In various embodiments, a milling tool that can be substantially spherical, also referred to as a lollipop tool or ball-end mill, can be used to cut horizontal grooves 352 in the sidewalls using a lateral motion. As shown in FIG. 3, a lollipop tool with a substantially spherical body has been used to cut these horizontal grooves as retention features 350.

As can be seen in FIG. 3, the dental components 120 have been milled with smooth surfaces, while the sidewalls of the remaining puck have been milled with retention grooves 352 that will provide additional purchase for the wax matrix. The sidewalls of the remaining puck that surround the voids can also be referred to as boundaries 362, and the boundaries around the dental components can hold the wax in and around the dental components. The boundaries 362 create a well around the dental components that can be filled with wax. The boundaries can have retention grooves 352 that can help to secure the wax in place within the puck after the wax cools and solidifies.

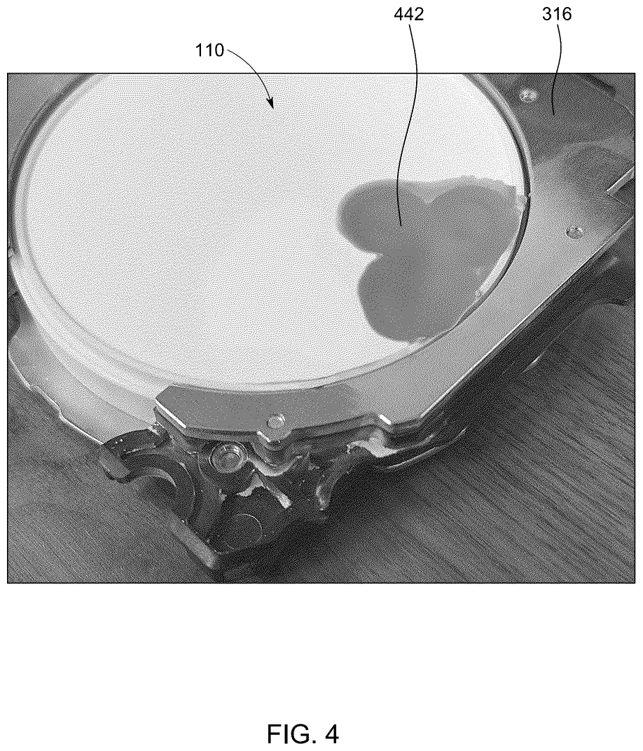

FIG. 4 is a perspective view of a puck 110 partially filled with wax 442, according to an exemplary embodiment. After the multitude of dental components are partially milled in the first milling step, a wax can be poured into the well. The wax 442 can fill in each of the cavities 122 of each of the hollow dental components, and the wax can surround the partially milled exterior sides 126 of each dental component. The wax can fill in the voids 364 between the dental components and the headspace 358 above the dental components. In various embodiments, the wax can also fill the puck from side to side, so that the wax contacts the support frame around the puck, and the support frame can continue to support the puck and can also support the wax after portions of the puck are milled away in the second milling step. By filling the support frame with the wax, the wax can be held in place by the support frame when additional puck material is milled away.

After the wax has hardened, the wax can securely hold all of the dental components in a firm wax support matrix. The wax matrix provides structural support that allows the dental components to be completely milled free from the puck without the need for sprues or connecting bridges.

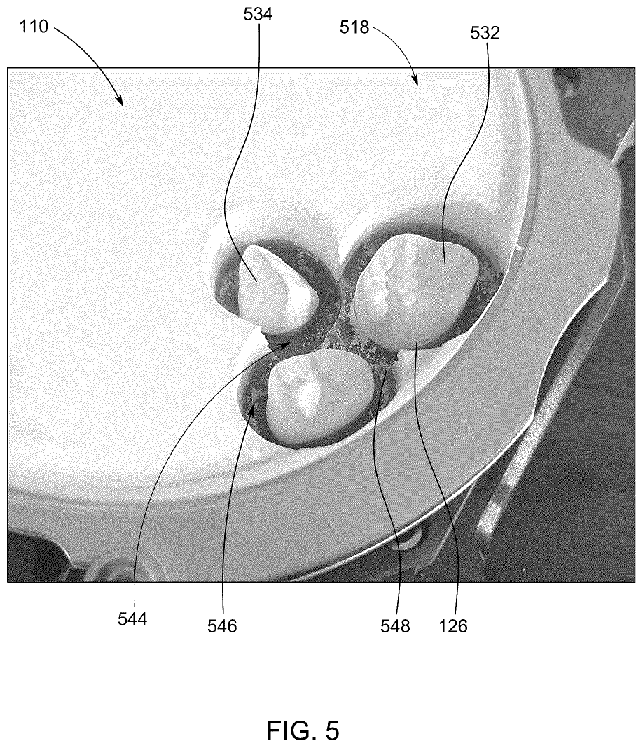

FIG. 5 is a perspective view of the second side 518 of the puck 110 with the exterior sides 126 of the dental components fully milled, according to an illustrative embodiment. In a second milling step, the second side 518 of the puck can be milled. Similar to the first milling step, in various embodiments, a milling tool path can start by milling dental components in the middle of the puck and work outwards toward the edges.

In the second milling step, the exterior sides 126 of the dental components can be completely milled. The exterior sides can include the top surfaces 532 of the dental components and the outer sides 534. In this second step, the top surfaces 532, also referred to as the occlusal or incisal surfaces of the teeth, can be milled to their final finished form. In this second step, the outer sides 534 of the dental components, also referred to as distal, lingual, mesial, buccal, and/or labial sides can also be completely milled to their final finished form. When the second milling is completed, each dental component has been fully and completely milled such that the surface is clean and smooth, and each dental component is completely separate from the neighboring components and any remainder of the puck. That is to say, each dental component is fully surrounded by an air gap 544 so that the dental component is only in contact with the supporting wax 442 and is otherwise surrounded by the air gap around each component.

The above description describes milling the interior cavity portions of the dental components in the first milling step, and then after adding wax, milling the exterior occlusal surfaces in the second step. However, it should be clear that the process can also be performed by milling the exterior occlusal surfaces in the first milling step, and then adding wax and milling the interior cavity portions as the second milling step. In the interest of brevity and ease of explanation, the process is described throughout this document as milling the cavity side first and the occlusal surfaces second, however, it should be clear that either sequence is expressly contemplated by this disclosure.

As the puck is being milled, the dental components that are farthest from the fixture supports are more fragile and vulnerable to breakage due to reduced structural support. In the case of a circular or disk-shaped puck with a support structure encircling and surrounding the disk, the center area of the puck and supporting wax structure is more fragile and vulnerable to breakage than the outer edges of the puck and supporting wax structure which are closer to the surrounding support. To address this structural weakness in a circular puck with a surrounding support, the center can be milled first, so that the surrounding areas of the puck can provide as much support as possible during the initial milling operations. In other embodiments with supports along less than all sides of the puck, the areas furthest from the supports can be milled first to maximize the structural support provided by the remaining puck material.

Although the wax matrix provides substantial support, it may not be as strong as the original puck material. Therefore, in the first milling step, the milling process can include milling the first side at a greater depth at the center of the puck, and then at a gradually reduced depth into the first side as the milling process moves closer to the fixture supports. For circular pucks, this can mean the dental components in the middle of the puck are cut at a greater depth into the first side of the puck, so that they require less milling in the second step compared to components closer to the supports of the puck. This approach helps to overcome the structural weakness inherent in the center of the puck, furthest from the edges, because that center area requires reduced milling in the second step, on the second side, as compared to components closer to the edge that have been milled at a reduced depth on the first side in the first milling step. This allows for maximum wax depth and strength at the middle of the puck during the second milling step, while also allowing the puck thickness to remain greater closer to the edges to help support the wax matrix. By maximizing wax depth in the center of the puck, the wax is better able to support the more fragile center area during the second milling operation. By maintaining greater puck thickness closer to the edges, the puck can help to support the wax matrix as the wax matrix is supporting the milling operations at the center of the puck.

In various embodiments, the dental components farthest from the supports can be cut on the first side at a deeper depth, resulting in a thicker wax base in those areas. In various embodiments, all dental components can be cut to the same or similar depth on the first side, so that the depth of the wax base is substantially uniform across all of the components being cut in a single milling event, regardless of distance to the supports. In various embodiments, the dental components farthest from the supports can be cut on the first side at a shallower depth. In various embodiments, the thicknesses of wax on the first side and the thicknesses of the remaining puck on the unmilled second side can be adjusted depending on factors including the size and geometry of the components being milled, the material properties and consistency of the wax, the material properties of the puck, and other factors. The thicknesses of wax base on the first side and the thicknesses of the remaining puck on the unmilled second side can be optimized to maximize structural strength during milling of the second side so as to ensure the dental components remain solidly fixed in place while the second side is milled completely without sprues. In various embodiments, the first side can be milled to a greater depth than the second side, resulting in a thicker, stronger wax base that provides enhanced support during the second milling operation.

Various versions of the milling process can be performed in various embodiments. Two exemplary process variations are described below.

An uninterrupted milling process allows the puck and fixture to remain mounted to the milling machine throughout the entire process until completion. An uninterrupted milling process is suitable for a milling machine where there is sufficient room to clean and dry the partially milled puck while the fixture remains clamped into the machine, and where the user is able to program the machine's CNC controller to pause after the first milling step, move the fixture into appropriate positions for cleaning, drying, and pouring the wax, and initiate a dwell command that allows the supporting wax to fully cure before resuming milling operations.

An NC file can be calculated that includes both milling steps-the cavity side and the occlusal side. The NC file can contain a pause code to provide the machine operator the ability to pour wax mid-program without removing the puck from the machine. The first part of the NC file yields a finished interior cavity, margin line, and outer void area up to the equator. The machine is paused for a cleaning phase, and the machine can present the puck for cleaning by rotating or repositioning the fixture. Cleaning can be performed with distilled water, compressed air, or both. In various embodiments, an uninterrupted milling process can include a pause in the milling operations with the puck remaining mounted in the machine and turned outward to face the user during the cleaning phase.

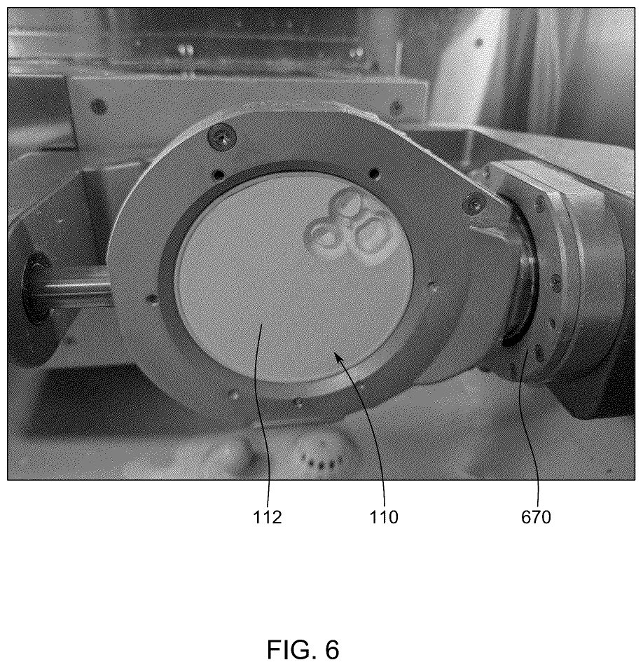

FIG. 6 is a perspective view of a milling machine 670 that has paused the milling process for cleaning, according to an illustrative embodiment. The milling machine 670 can rotate or reposition the fixture to point the first side 112 of the puck 110 outward to face a user so the user can clean away any dust or debris that remains from the milling process. The cleaning phase allows the user to clean the puck so that the wax can properly adhere to the puck and form the strongest possible support matrix for the dental components during the second milling phase.

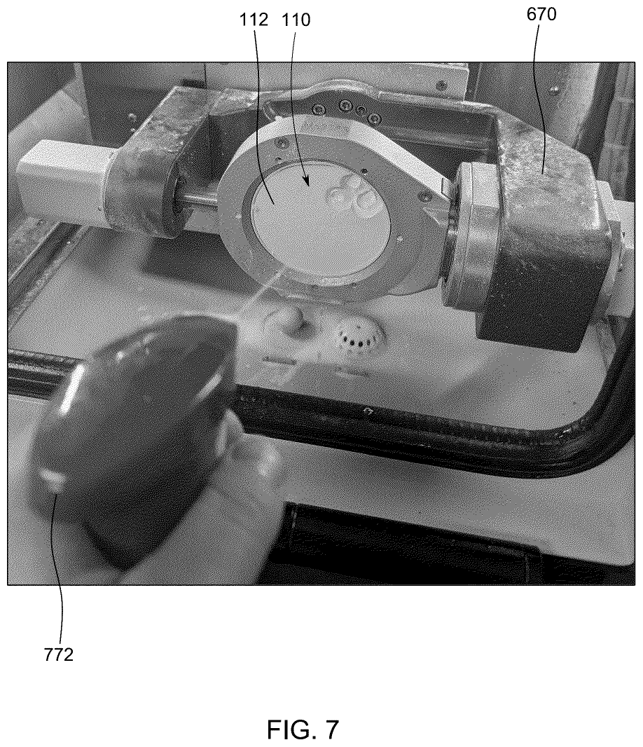

FIG. 7 is a perspective view of a user spraying distilled water 772 to clean away milling dust, according to an illustrative embodiment. As shown, a user can spray distilled water onto the puck 110 while the puck remains mounted in the milling machine 670. The user can wash away the dust and debris to ensure proper wax adhesion and sealing.

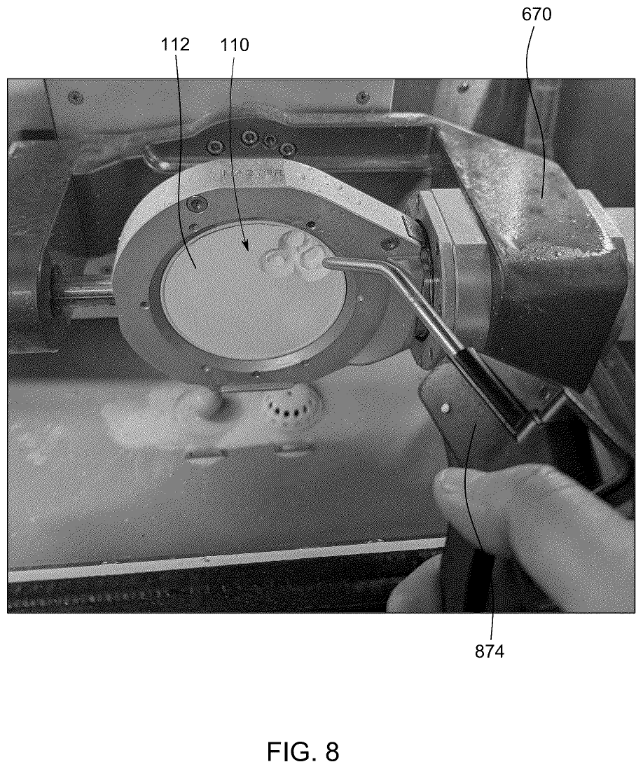

FIG. 8 is a perspective view of a user using compressed air 874 to clean away milling dust and/or dry the puck, according to an illustrative embodiment. The user can use compressed air to clear away any remaining dust and debris and/or to dry the puck 110 to ensure optimal wax adhesion to the puck surfaces.

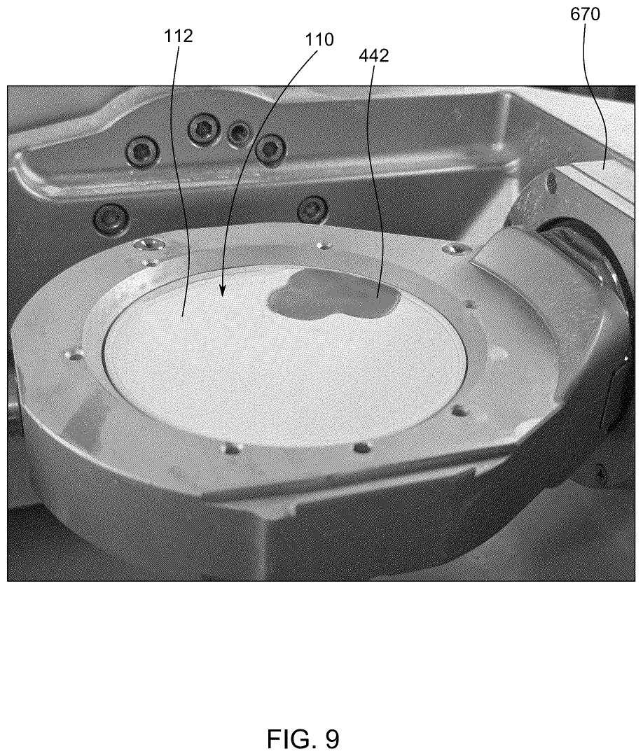

FIG. 9 is a perspective view of the clean and dry puck 110 returned to a horizontal orientation, with molten wax 442 poured into the well, according to an illustrative embodiment. The puck can be preheated using an external heat source, and the temperature of the puck material should be approximately 150 °F to promote optimal wax adhesion. The wax can be heated to a temperature in the range of 300-350 °F to maintain fluidity for pouring. The milling program can level the puck and fixture to a horizontal orientation for wax to be poured, with wax first filling the interior cavities, then filling the voids, and finally filling to the top of the boundary walls to form the wax base.

Wax can be poured into the cavities 122 and the voids 364, and the user can continue to pour wax so that a wax base can be formed in the headspace 358. Wax can be poured into the headspace until the wax level is at least as high or higher than the plane of the first surface 112 of the puck. Wax can be poured into the headspace until the wax fills the fixture from side to side, thereby creating a wax base that can be bonded to the fixture to maximize structural strength during the second phase of the milling.

In various embodiments, an interruptable milling process can be used for a dry milling machine where there is insufficient room inside the machining cabinet to clean the milling debris such as dust after the first milling step or to dispense the wax within the machine, and/or where the user is unable to program the machine's CNC controller to follow the required steps for the uninterrupted milling process. The interruptable milling process can involve calculating two separate NC files and loading and running them independently at different times.

NC file 1 is calculated with only cavity-side toolpaths. This first NC file yields a finished interior cavity, margin line, outer cavity area, and skirt 214 around each dental component. The equator line 128 of each dental component is used as a toolpath limit to prevent the milling from creating any through-holes in the puck that would allow wax to leak through. After completing the first NC file, the puck and fixture assembly is removed from the machine together as a unit, which preserves the precise location and orientation of the puck and fixture relative to the milling machine for subsequent remounting.

The interruptable milling process allows the puck to be heated with a heat gun, heat lamp, or other heat source external to the milling machine to ensure optimal adhesion of the wax to the puck. In various embodiments, wax can be heated to a temperature in the range of 300-350 °F to maintain proper fluidity, and the puck surface can be heated to approximately 150 °F for optimal wax adhesion. The heated wax is poured into the well, starting with the interior cavities 122, then filling the voids 364, and then filling the headspace 358. As shown in FIG. 4, the wax can entirely fill the milled well and can extend above the surface of the first side 112. In various embodiments, the wax can cover the first surface of the puck and can contact the fixture to ensure additional structural strength. The wax is allowed to cure for a period of time, for example approximately 15 minutes, to achieve sufficient hardness.

After the wax has cured, the puck and fixture assembly can be placed back into the milling machine in the same orientation, and NC file #2 is loaded into the machine controller. NC file #2 contains the toolpaths to finish milling the occlusal side of the dental components. After the wax is fully cured and provides adequate support, the second side 518 of the puck can be machined to complete the occlusal surfaces of the dental components.

After the milling process is complete on both sides, and the dental components have been fully milled, the individual components can be extracted from the wax matrix and cleaned. Turning briefly to FIG. 5, several dental components 120 are shown after the second milling step is complete. The finished dental components are cut completely free from the puck material, with no material bridges or sprues connecting them to the remnant puck. The exterior surfaces of the finished dental components are fully milled and smooth, and are free from sprues or connection points that would require manual removal. The finished dental components are securely held in place by the wax matrix 546, and the wax base 548 of the wax matrix securely holds the dental components in their proper positions. In various embodiments, the wax base 548 extends to contact and bond with the remaining pucks boundary walls, providing additional structural support.

The wax can be removed by melting with a heat gun or by placing the assembly in an oven until the dental components are released from the wax matrix. Hot air can be directed at the wax to melt the wax, including wax within the cavities of the dental components, to facilitate separation.

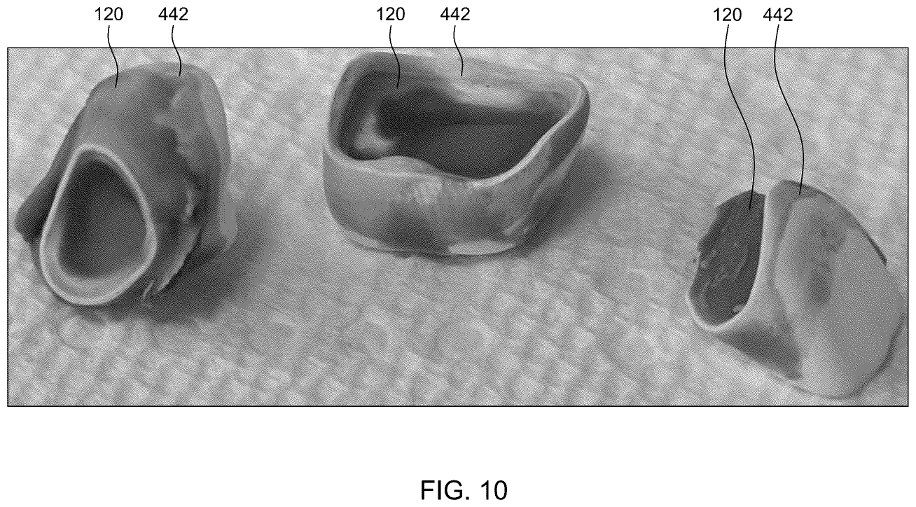

FIG. 10 shows dental components 120 that have been separated from the wax base 548, according to an illustrative embodiment. The dental components have been released from the wax matrix through initial heating, however, the dental components remain covered with residual wax 442 that continues to adhere to the surfaces of the dental components.

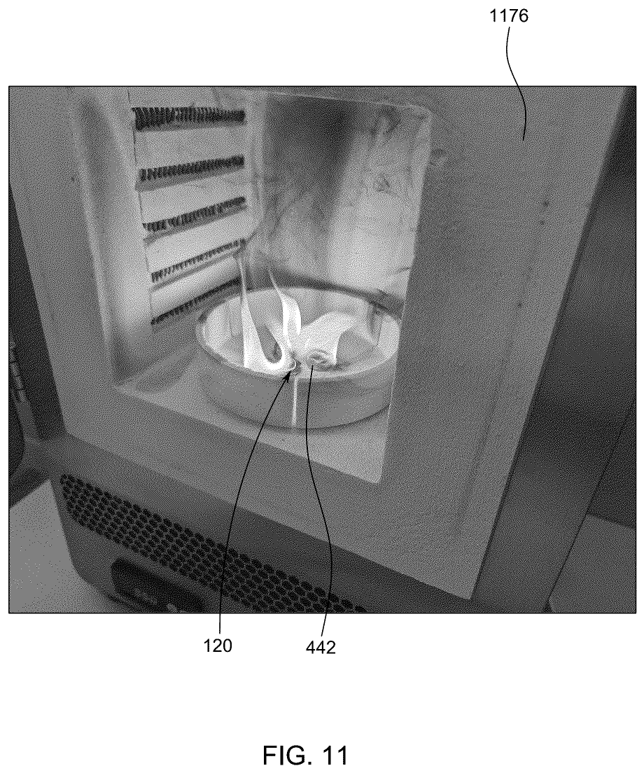

FIG. 11 is a perspective view of the wax-covered dental components 120 positioned in an oven 1176, according to an illustrative embodiment. The wax-covered dental components can be placed in a high temperature oven to burn away the remaining wax residue. At sufficiently high temperatures, the wax can burn away completely through combustion, leaving only the clean dental components. In various embodiments, a high temperature oven can be operated at approximately 350 °C to completely burn away and remove the wax residue from the dental components.

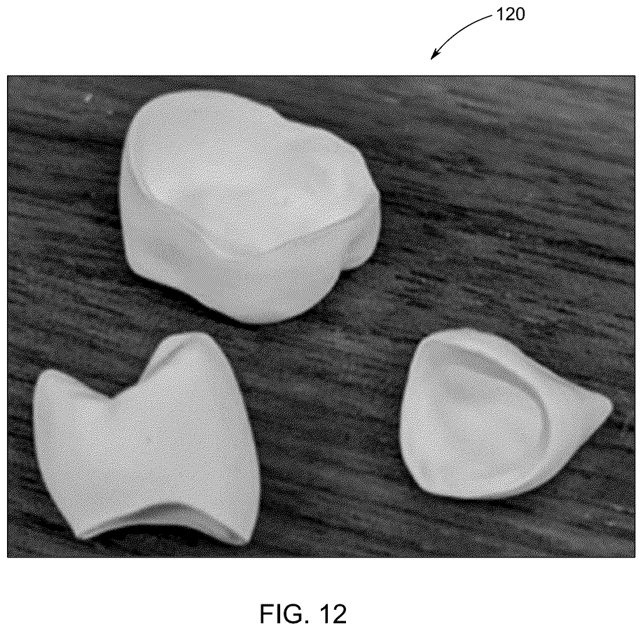

FIG. 12 is a perspective view of finished dental components 120 after the wax has been completely burned away, according to an illustrative embodiment. The wax has been completely removed through the high-temperature burning process in the oven, and the dental components are now clean, free of residue, and ready to be used for various dental applications, such as crowns or other dental prosthetics.

As described above, one or more dental components can be milled together in a single milling event. In the embodiment illustrated in the figures, three dental components have been milled together in a single milling event. The components that are milled together in a single milling event can be surrounded by a single continuous boundary wall 362 that defines a well for containing the wax. The system can mill the first side of a group of dental components together at the same time, leaving a boundary wall around that group of dental components. The well formed by the boundary can be filled with wax, and then the second side can be milled to complete the dental components. After completion, the wax and dental components can be removed from the puck, leaving a cutout 1380 extending through the thickness of the puck. In various embodiments, additional dental components can be milled from the same puck in subsequent milling events.

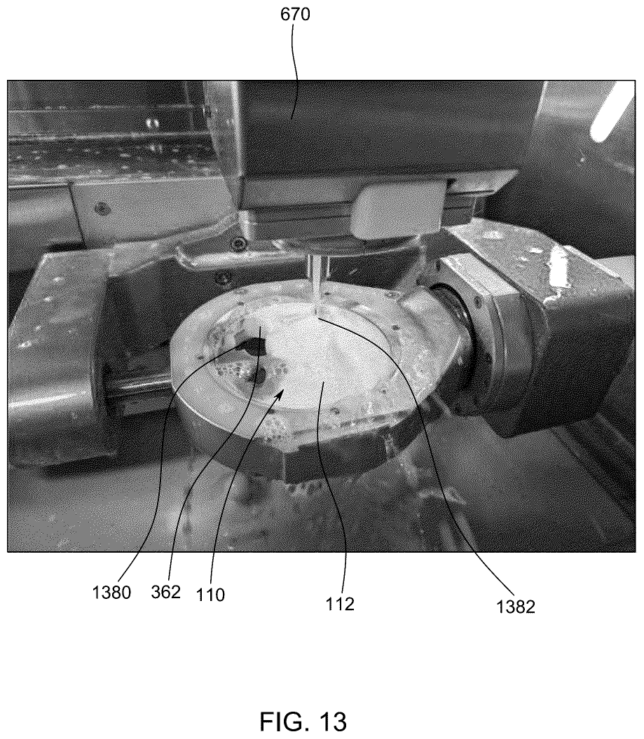

FIG. 13 is a perspective view of a puck 110 that has already had several dental components milled, completed, and removed in a previous milling event, and is now ready to have new dental components milled out in a subsequent milling event, according to an illustrative embodiment. A cutout 1380 may be present extending through the puck where dental components have been previously milled and removed. The boundary wall 362 from the previous milling session defines the perimeter of the cutout.

In a separate milling event that can occur on a different day or at a different time, a new group of dental components can be milled from the same puck. The system can maintain a record of which areas of the puck have already been milled and removed, and a new group of dental components can be digitally laid out and milled in a new, unused zone 1382 of the puck. The second group of dental components can be positioned and milled in an unused zone of the puck that is sufficiently separated from the first group of dental components so that the boundary walls of the first group and the second group do not overlap or interfere. That is to say, after milling the first side of the second group, the second group will have a distinct boundary wall around the second group that does not overlap with the boundary wall of the first group, so that wax can be properly contained by the boundary wall of the second group without leaking through areas previously milled.

The subsequent milling event follows the same process as described above milling the cavities completely to their finished form, and milling the exterior sides of the dental components down to the equator, leaving a skirt of connected material around the dental components. The cavities, the voids, and the headspace can then be filled with wax to create a wax matrix with a wax base that supports the partially milled dental components.

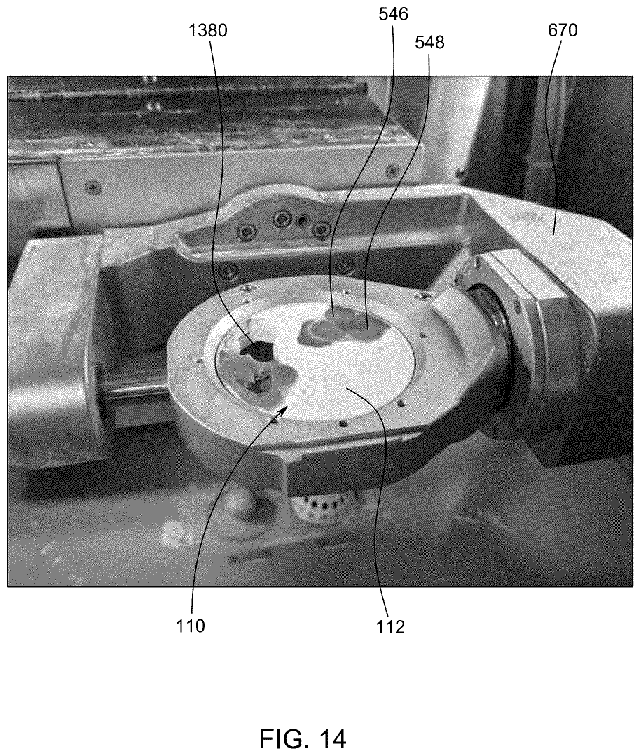

FIG. 14 is a perspective view of the subsequent milling event, showing the well filled with wax 442, according to an illustrative embodiment. After the wax has cooled and solidified within the well defined by the boundary wall surrounding the subsequent group of dental components, the second side of the subsequent group can be milled to complete the dental components.

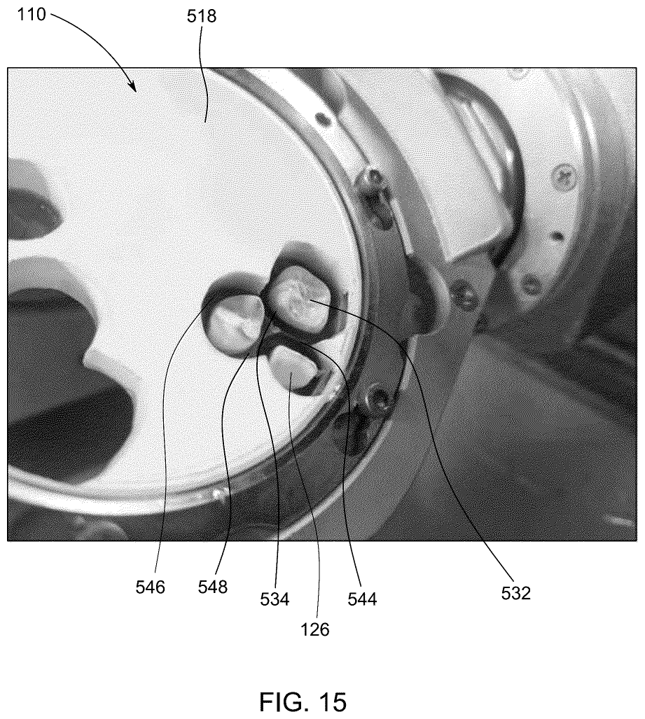

FIG. 15 is a perspective view of the subsequent milling event after the second side 518 has been completed, showing the subsequent dental components held in place by the wax matrix 546, according to an illustrative embodiment. As the second side is milled, the wax matrix supports the dental components, allowing them to be milled completely without sprues or connecting bridges. The system continues to maintain a record of which areas of the puck have already been milled and identifies where additional dental components can be milled in future milling events. So long as sufficient unused space remains on the puck, the system can continue to lay out new dental components in unused zones of the puck and mill those new dental components while leaving an unbroken boundary wall around the components being milled in each milling event.

Each milling event can mill one or more dental components at a time, with those dental components surrounded by a boundary wall that creates a well for wax containment. Future milling events can reuse the same puck by milling in different unused areas of the puck while leaving a complete boundary wall around all dental components milled in each single milling event. This process allows standard, commercially available pucks and standard milling equipment to be used to completely mill dental components without sprues or other surface defects, and allows the same standard puck to be efficiently reused multiple times across multiple milling events, reducing material waste and improving production flexibility.

Various embodiments of the milling process for dental components can include alternative process sequences. In one embodiment, the occlusal side can be finished first in the first milling step, followed by the wax addition steps, and then completed by milling the cavity side in the second milling step. For additional mechanical retention and interlocking with the wax, toolpaths may be implemented to create notches, undercuts, or other retention features in the boundary walls of the puck. Various forms of wax suitable for use in the process can include wax pellets that are small drops that are easy to melt, or wax sticks that can be fed through a hot glue gun type dispenser. A stick form wax with a hot glue gun dispenser would eliminate the need for separately heating the wax on a hot plate before dispensing, simplifying the process.

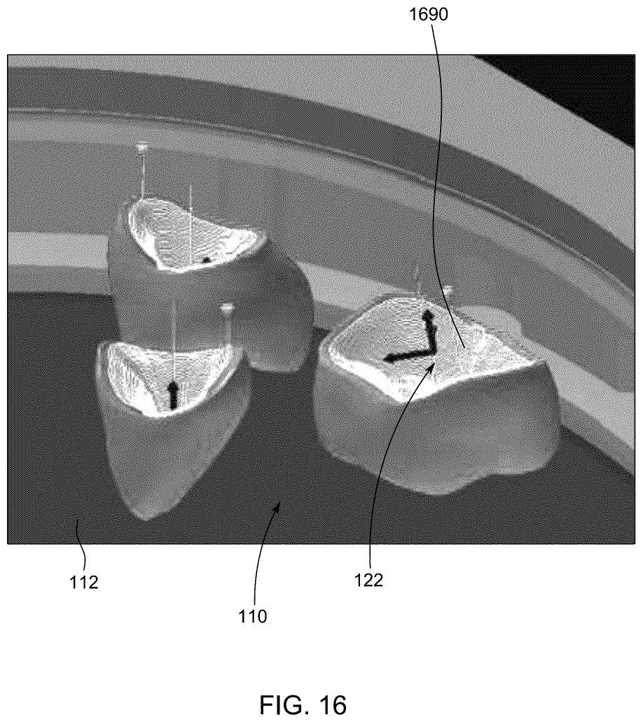

The milling process can commence on the first side with milling the interior of the cavity. FIG. 16 shows the cavity tool path 1690 for finishing the inside of the cavity 122, according to an illustrative embodiment.

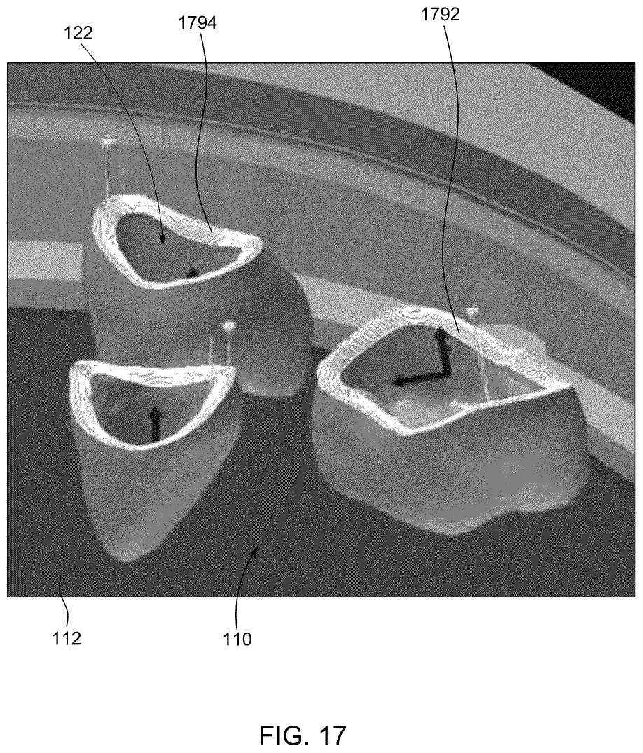

FIG. 17 shows the bottom surface horizontal tool path 1794 for milling the bottom surfaces 1792 of the dental components, according to an illustrative embodiment. The tool path can mill the bottom, gum-facing surface of each dental component, also called the margins, using tool paths that that are closer together and more conservative to preserve these delicate, chip-prone edges.

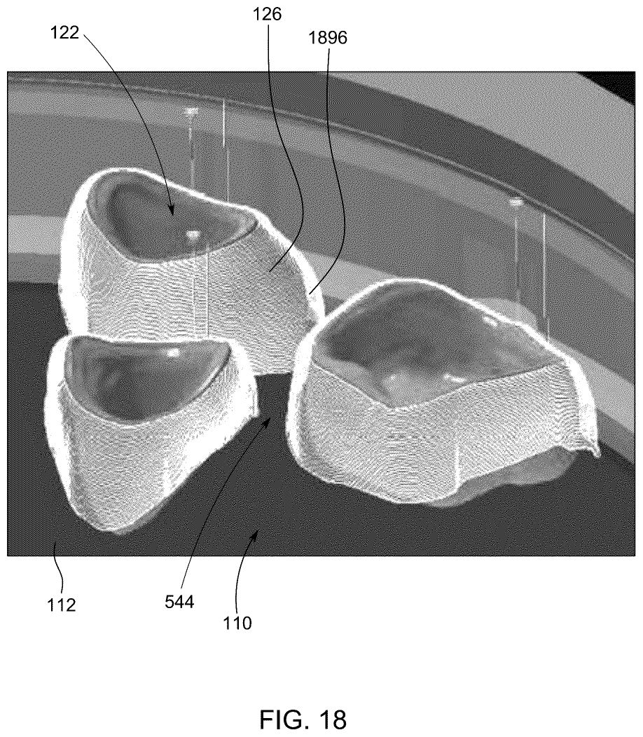

FIG. 18 shows the exterior side tool path 1896 for finishing the exterior sides 126 of the dental components, according to an illustrative embodiment. The tool path can mill the exterior sides of the dental components using tool paths that progressively encircle the dental component and mill the exterior sides to a smooth finished surface.

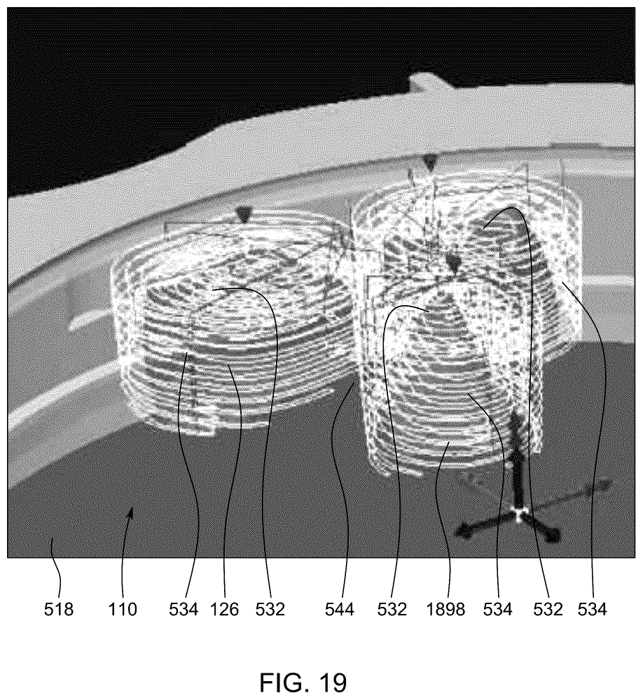

FIG. 19 shows the roughing tool path 1898 for milling the outer surfaces 534 of the second side 518, according to an illustrative embodiment. The tool path can start from the outer surface of the second side and can make progressive horizontal passes moving inward until the tool path encircles and completely cuts out each of the dental components from the remaining puck material. The tool path can fully and completely mill the exterior surfaces of the dental components, completely free of sprues or connecting bridges, and leaving smooth, unblemished surfaces suitable for dental applications without requiring manual grinding or polishing.

A method for sprueless milling of multiple dental components from a single puck includes several steps that enable complete milling of dental components without requiring sprues or connecting bridges. The method can be performed using standard, commercially available milling equipment and standard milling tools, without requiring specialized machinery or custom tooling.

The method starts with a puck made from a starting block of material suitable for dental applications. The puck can be a standard, commercially available disk having a diameter in a range between 98 and 110 mm and a thickness in a range between 10 mm and 35 mm. The puck can be mounted in a fixture of a milling machine, wherein the fixture can hold the puck along one side, along multiple sides, or can completely or partially encircle the puck.

A first milling step includes milling a first side of the puck to partially form a plurality of dental components. The first milling step can include milling interior cavities of hollow dental components to their final finished form, and milling exterior sides of the dental components up to or close to an equator line of each dental component, wherein the equator line represents the widest area around the perimeter of each dental component. The first milling step terminates at or slightly beyond the equator line such that a continuous skirt of material remains around each dental component, preventing the formation of through-holes in the puck. The first milling step can further include milling retention features into boundary walls of the remaining puck material, wherein the retention features can include horizontal grooves, dimples, islands, extensions, or other geometric features that provide mechanical interlocking with wax to be added in a subsequent step.

After completing the first milling step, the method includes adding wax to the puck. The wax can be heated to a temperature in a range of 300-350 °F to maintain fluidity for pouring. The puck can be preheated to approximately 150 °F to promote optimal wax adhesion. The wax is poured into a well formed by the first milling step, wherein the well includes cavities within the dental components, voids between the dental components, and headspace above the dental components. The wax fills the cavities, voids, and headspace to form a wax matrix with a wax base that fully encircles and supports the partially milled dental components. The wax is allowed to cure for a period of time sufficient to achieve adequate hardness, for example approximately 15 minutes, before proceeding to the second milling step.

A second milling step includes milling a second side of the puck to complete the dental components. The second milling step can include milling top surfaces and remaining portions of exterior sides of the dental components to their final finished form. The second milling step completely separates each dental component from the remaining puck material, such that each dental component is surrounded by an air gap and is connected only to the wax matrix. The wax matrix provides sufficient structural support during the second milling step to allow complete milling of the dental components without requiring sprues or connecting bridges.

The milling tool paths used in both the first and second milling steps can include predominantly lateral movements rather than vertical movements. For pucks with surrounding fixtures, the tool paths can start by milling dental components in the center of the puck and work progressively outward toward the perimeter. The lateral tool paths allow the milling tool to apply force laterally against solid sections of the puck or sections fully supported by the wax matrix, avoiding direct downward force that could cause breakage of the puck or dental components.

After completing the second milling step, the method includes extracting the dental components from the wax matrix. The wax can be melted using a heat gun or by placing the assembly in an oven to release the dental components from the wax matrix. Residual wax adhering to the surfaces of the dental components can be removed by placing the dental components in a high temperature oven operated at approximately 350 °C, wherein the wax is burned away completely through combustion, leaving clean dental components ready for use in dental applications.

In various embodiments, the method can further include reusing the same puck in multiple milling events. After extracting dental components from a first milling event, a cutout remains in the puck where the dental components were milled. The system maintains a record of which areas of the puck have been milled and identifies unused zones of the puck. In a subsequent milling event, new dental components can be laid out in an unused zone of the puck that is sufficiently separated from previously milled areas such that boundary walls of different milling events do not overlap. The subsequent milling event follows the same process of milling a first side, adding wax, and milling a second side to produce additional dental components from the same puck.

The method can be performed as an uninterrupted process wherein the puck remains mounted in the milling machine throughout both milling steps, with a pause between steps for cleaning and wax addition. Alternatively, the method can be performed as an interruptable process wherein the puck is removed from the milling machine after the first milling step for external cleaning, heating, and wax addition, and then remounted in the milling machine for the second milling step. The method can accommodate milling the cavity side first followed by the occlusal side, or alternatively, milling the occlusal side first followed by the cavity side.

The system tracks and manages unused zones across multiple milling events through several integrated mechanisms. The system can maintain digital records of the three-dimensional geometry of the puck, including the locations and boundaries of all previously milled areas. After each milling event is completed and dental components are extracted, the system updates its records to reflect the cutout that remains in the puck, including the precise three-dimensional coordinates of the boundary walls that define the perimeter of the milled area. This digital tracking allows the system to accurately identify which portions of the puck remain available as unused zones for future milling operations.

When planning a subsequent milling event, the system analyzes the remaining unused zones of the puck to determine suitable locations for positioning new dental components. The system can calculate the minimum required separation distance between a new group of dental components and any previously milled areas to ensure that the boundary walls of different milling events do not overlap or interfere. This minimum separation distance can be determined based on factors including the thickness of the boundary walls required to contain wax, the structural requirements for supporting the wax matrix, and safety margins to account for tool deflection or positioning tolerances during milling. The system can evaluate multiple potential layouts for new dental components within the unused zones and can select an optimal layout that maximizes material utilization while maintaining adequate separation from previously milled areas.

The geometric constraints for positioning dental components in unused zones can include ensuring that each new group of dental components is surrounded by a complete, unbroken boundary wall that does not intersect with boundary walls from previous milling events. The boundary wall for each milling event must form a continuous perimeter that can contain liquid wax without leakage through previously milled cutouts. The system can verify that the planned boundary wall for a new group of dental components does not pass through any existing cutouts in the puck, and that sufficient solid puck material remains to form the complete boundary wall. In various embodiments, the system can require a minimum wall thickness between adjacent boundary walls to ensure structural integrity, wherein the minimum wall thickness can be, for example, in a range of 2 mm to 5 mm depending on the puck material properties and the size of the dental components being milled.

The system can optimize the layout of dental components across multiple milling events to maximize the total number of dental components that can be produced from a single puck over its useful lifetime. The optimization can account for the progressive weakening of the puck structure as material is removed in successive milling events. The system can prioritize milling larger dental components or groups requiring larger boundary areas in earlier milling events when more unused area is available, and can reserve smaller unused zones for smaller dental components in later milling events. The system can also account for the locations of fixture supports and can plan layouts that maintain adequate puck material near the supports to preserve structural integrity throughout multiple milling events.

The system can track material usage and remaining capacity of each puck through a puck identification system. The system retrieve the stored history of previous milling events performed on each specific puck. The stored history can include the three-dimensional geometry of all cutouts, the locations of all boundary walls, the total material removed, and the remaining unused zones. This tracking system allows pucks to be removed from the milling machine between milling events, and stored for future use while remaining mounted within the fixture or adapter, and ensures that when a puck is reloaded into the milling machine for a subsequent milling event, the system accurately knows which areas have been used and which areas remain available. Pucks can be removed from the machine while remaining mounted in the fixture or adapter. This can help to ensure the pucks remain in the same orientation each time they are re-loaded back into the milling machine.

The workflow for multiple milling events from the same puck can include the following sequence. In a first milling event, the system lays out a first group of dental components in an unused zone of a new puck, typically starting at the center for circular pucks with surrounding supports. The first milling event proceeds through the first milling step, wax addition, and second milling step as previously described, resulting in completed dental components and a cutout in the puck. The system records the geometry of the cutout and updates the puck's digital record. The dental components are extracted and the puck is stored for future use. In a subsequent milling event that can occur hours, days, or weeks later, the same puck is retrieved and loaded into the milling machine. The system retrieves the stored history, and identifies remaining unused zones. The system lays out a second group of dental components in an unused zone with adequate separation from the first cutout. The subsequent milling event proceeds through the same sequence of first milling step, wax addition, and second milling step. This process can be repeated for additional milling events until insufficient unused zone area remains to accommodate additional dental components with required boundary walls and separation distances.

The system or the end-user can determine when a puck has reached the end of its useful life and should be retired from service. This determination can be based on calculating the largest continuous unused zone remaining in the puck and comparing it to the minimum area required to mill the smallest dental component with an adequate boundary wall. When the largest remaining unused zone falls below this minimum threshold, the puck can be marked as fully utilized and removed from the inventory of available pucks. In various embodiments, the system can also retire a puck when the cumulative material removal has reduced the structural integrity below a safe threshold, even if some unused zones remain, to prevent puck failure during milling operations.

Although this invention has been disclosed in the context of certain preferred embodiments and examples, it should be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Note also, as used herein the terms “process” and/or “processor” should be taken broadly to include a variety of electronic hardware and/or software based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A method for sprueless milling of multiple dental components from a single puck, comprising:
milling a first side of the puck to partially form a plurality of dental components, wherein milling the first side includes milling interior cavities of the dental components to a finished form and milling exterior sides of the dental components up to an equator line of each dental component, wherein a continuous skirt of material remains around each dental component preventing formation of through-holes in the puck;
adding wax to the puck, wherein the wax fills cavities within the dental components, voids between the dental components, and headspace above the dental components to form a wax matrix that supports the partially milled dental components; and
milling a second side of the puck to complete the dental components, wherein milling the second side completely separates each dental component from remaining puck material such that each dental component is surrounded by an air gap and is connected only to the wax matrix.

2. The method of claim 1, wherein milling the first side further comprises milling retention features into boundary walls of remaining puck material, wherein the retention features provide mechanical interlocking with the wax matrix.

3. The method of claim 2, wherein the retention features comprise horizontal grooves milled into the boundary walls using lateral tool movements.

4. The method of claim 2, wherein the retention features comprise at least one of dimples, extensions, or undercuts formed in the boundary walls.

5. The method of claim 1, wherein milling the first side and milling the second side utilize predominantly lateral tool movements that apply force laterally against solid sections of the puck.

6. The method of claim 5, wherein the puck is circular and held by a surrounding fixture, and wherein the tool movements start at a center of the puck and work progressively outward toward a perimeter.

7. The method of claim 1, wherein milling the first side includes milling the first side at a greater depth at a center of the puck and at a gradually reduced depth moving toward edges of the puck, resulting in a thicker wax matrix at the center.

8. The method of claim 1, further comprising:
extracting the dental components from the wax matrix by melting the wax; and
removing residual wax from surfaces of the dental components by heating the dental components in an oven to burn away the residual wax.

9. The method of claim 1, wherein the puck remains mounted in a milling machine throughout milling the first side, adding wax, and milling the second side.

10. The method of claim 9, further comprising:
pausing the milling machine after milling the first side;
cleaning and heating the puck while the puck remains mounted in the milling machine; and
resuming the milling machine to mill the second side after the wax has cured.

11. The method of claim 1, further comprising:
removing the puck from a milling machine after milling the first side;
cleaning and heating the puck externally to the milling machine;
adding the wax while the puck is external to the milling machine; and
remounting the puck in the milling machine for milling the second side.

12. The method of claim 1, further comprising milling a second set of dental components from the same puck after the first set of dental components are complete, wherein the first milling event produces a first group of finished dental components, leaving a first cutout in the puck defined by a first boundary wall; and
performing a second milling event on the puck, wherein the second milling event produces a second group of dental components in the unused zone according to the method of claim 1, leaving a second cutout in the puck defined by a second boundary wall that does not overlap with the first boundary wall.

13. The method of claim 12, further comprising identifying an unused zone in the puck, wherein identifying the unused zone comprises:
maintaining digital records of three-dimensional coordinates of all previously milled areas of the puck;
calculating available unused zones based on the digital records; and
evaluating multiple potential layouts for the second group of dental components within the unused zones.

14. The method of claim 12, further comprising determining that the puck has reached end of useful life when a largest remaining unused zone is insufficient to accommodate a smallest dental component with an adequate boundary wall.

15. A system for sprueless milling of multiple dental components, comprising:
a milling machine having a fixture adapted to hold a puck;
a controller programmed to execute milling instructions for:
milling a first side of the puck to partially form a plurality of dental components, wherein milling the first side includes milling interior cavities of the dental components and milling exterior sides of the dental components up to an equator line, leaving a continuous skirt of material around each dental component;
wherein the controller is further programmed to execute milling instructions for milling a second side of the puck to complete the dental components, completely separating each dental component from remaining puck material while the dental components remain supported by a wax matrix.

16. The system of claim 15, wherein the controller is programmed to execute tool paths comprising predominantly lateral movements that apply force laterally against solid sections of the puck.

17. The system of claim 15, wherein the controller is programmed to mill retention features into boundary walls during milling of the first side.

18. The system of claim 15, further comprising a tracking module programmed to:
maintain digital records of three-dimensional geometry of the puck including locations of previously milled areas;
identify unused zones of the puck; and
generate milling instructions for subsequent milling events in the unused zones with boundary walls that do not overlap with previously milled areas.
